(19) United States
(12) Patent Application Publication
(10) Pub. No.: US 2007/0196593 A1
(43) Pub. Date: Aug. 23, 2007

(54) BONDING STRUCTURE OF PATTERN ELECTRODES USING ULTRA-VIOLET RAYS AND METHOD FOR BONDING PATTERN ELECTRODES USING THE SAME

(75) Inventor: Min-Ho Kim, SEOUL (KR)

Correspondence Address: KNOBBE MARTENS OLSON & BEAR LLP, 2040 MAIN STREET, FOURTEENTH FLOOR, IRVINE, CA, 92614, US

(73) Assignee: NARAENANOTECH CORPORATION, YONGIN-CITY (KR)

(21) Appl. No.: 11/669,843

(22) Filed: Jan. 31, 2007

(30) Foreign Application Priority Data
Nov. 3, 2005 (KR) 1020050105025

(51) Int. Cl. C09K 19/00; G02F 1/1343

(52) U.S. Cl. 428/1.1; 349/147; 428/1.62

(57) ABSTRACT

The present invention relates to a bonding structure of pattern electrodes using ultra-violet rays and a method for bonding pattern electrodes using the same. A bonding structure of pattern electrodes using ultra-violet rays according to the present invention comprises a front or back glass panel; a plurality of front or back pattern electrodes formed on the front or back glass panel; a tape automatic bonding (TAB); a plurality of pattern electrodes formed on the TAB; and a UV curing layer coated either on the plurality of front or back pattern electrodes or on the plurality of pattern electrodes formed on the TAB, wherein a is bonding between the plurality of front or back pattern electrodes and the plurality of pattern electrodes formed on the TAB is made in a way that the UV curing layer is cured at a normal temperature by UV emitted from a UV emission device, under a condition that the plurality of front or back pattern electrodes and the plurality of pattern electrodes formed on the TAB are aligned with each other and a certain pressure is applied thereon by a certain pressure device.

### BACKGROUND

The present invention relates to a bonding structure of pattern electrodes using ultra-violet rays (UV) and a method for bonding pattern electrodes using the same. More specifically, the present invention relates to a bonding structure of pattern electrodes using UV and a method for bonding pattern electrodes using the same wherein a bonding between pattern electrodes formed on a glass panel of a plasma display panel (PDP) or a liquid crystal display (LCD) and pattern electrodes formed on a flexible printed circuit (FPC) for external connection is made by a UV curing agent at a normal temperature using UV.

### SUMMARY

According to a first aspect of the present invention, the present invention provides a bonding structure of pattern electrodes using ultra-violet rays comprising a front or back glass panel; a plurality of front or back pattern electrodes formed on the front or back glass panel; a tape automatic bonding (TAB); a plurality of pattern electrodes formed on the TAB; and a UV curing layer coated either on the plurality of front or back pattern electrodes or on the plurality of pattern electrodes formed on the TAB, wherein a bonding between the plurality of front or back pattern electrodes and the plurality of pattern electrodes formed on the TAB is made in a way that the UV curing layer is cured at a normal temperature by UV emitted from a UV emission device, under a condition that the plurality of front or back pattern electrodes and the plurality of pattern electrodes formed on the TAB are aligned with each other and a certain pressure is applied thereon by a certain pressure device.

According to a second aspect of the present invention, the present invention provides a method for bonding pattern electrodes using ultra-violet rays (UV) comprising a step of preparing a plurality of front or back pattern electrodes formed on a front or back glass panel; a step of preparing a plurality of pattern electrodes formed on each of a plurality of tape automatic bondings (TABs); a step of coating a UV curing layer either on the plurality of front or back pattern electrodes or on the plurality of TABs; a step of aligning the plurality of front or back pattern electrodes with the plurality of pattern electrodes formed on the plurality of TABs; and a step of curing the UV curing layer by using certain UV, while applying a certain pressure on the plurality of front or back pattern electrodes and the plurality of pattern electrodes formed on the plurality of TABs by a certain pressure device.

According to a third aspect of the present invention, the present invention provides a method for bonding pattern electrodes using ultra-violet rays (UV) comprising a) a step of coating a UV curing agent on a plurality of TABs, each of which is supposed to be attached to long sides A and B of one of two glass panels and a plurality of pattern electrodes is formed on; b) a step of aligning a plurality of pattern electrodes formed on the one of the two glass panels with the plurality of pattern electrodes formed on the plurality of TABs over the long sides A and B, and of UV curing while applying pressure; c) a step of coating the UV curing agent on another plurality of TABs, each of which is supposed to be attached to short sides A and B of the other glass panel and another plurality of pattern electrodes is formed on; and d) a step of aligning a plurality of pattern electrodes formed on the other glass panel with the another plurality of pattern electrodes formed on the another plurality of TABs over the short sides A and B, and of UV curing while applying pressure, wherein the UV curing agent is coated only on the plurality of TABs and the another plurality of TABs, or on positions of the plurality of pattern electrodes of the two glass panels to which the plurality of TABs and the another plurality of TABs are supposed to be attached.

According to a fourth aspect of the present invention, the present invention provides a method for bonding pattern electrodes using ultra-violet rays (UV) comprising a) a step of coating a UV curing agent on a plurality of TABs, each of which is supposed to be attached to long sides A and B of one of two glass panels and a plurality of pattern electrodes is formed on; b) a step of aligning a plurality of pattern electrodes formed on the one of the two glass panels with the plurality of pattern electrodes formed on the plurality of TABs over the long side A, and of UV curing while applying pressure; c) a step of aligning the plurality of pattern electrodes formed on the one of the two glass panels with the plurality of pattern electrodes formed on the plurality of TABs over the long side B, and of UV curing while applying pressure; d) a step of coating the UV curing agent on another plurality of TABs, each of which is supposed to be attached to short sides A and B of the other glass panel and another plurality of pattern electrodes is formed on; and e) a step of aligning a plurality of pattern electrodes formed on the other glass panel with the another plurality of pattern electrodes formed on the another plurality of TABs over the short sides A and B, and of UV curing while applying pressure, wherein the UV curing agent is coated only on the plurality of TABs and the another plurality of TABs, or on positions of the plurality of pattern electrodes of the two glass panels to which the plurality of TABs and the another plurality of TABs are supposed to be attached.

According to a fifth aspect of the present invention, the present invention provides a plasma display panel (PDP) having the bonding structure of pattern electrodes using ultra-violet rays (UV) according to the first aspect described above.

According to a sixth aspect of the present invention, the present invention provides a liquid crystal display (LCD) having the bonding structure of pattern electrodes using ultra-violet rays (UV) according to the first aspect described above.

According to a seventh aspect of the present invention, the present invention provides a plasma display panel (PDP) having a bonding structure of pattern electrodes which is manufactured by using a method for bonding pattern electrodes using ultra-violet rays (UV) according to the second aspect described above.

According to an eighth aspect of the present invention, the present invention provides a liquid crystal display (LCD) having a bonding structure of pattern electrodes which is manufactured by using a method for bonding pattern electrodes using ultra-violet rays (UV) according to the second aspect described above.

According to a ninth aspect of the present invention, the present invention provides a plasma display panel (PDP) having a bonding structure of pattern electrodes which is manufactured by using a method for bonding pattern electrodes using ultra-violet rays (UV) according to the third or fourth aspect described above.

According to a tenth aspect of the present invention, the present invention provides a liquid crystal display (LCD) having a bonding structure of pattern electrodes which is manufactured by using a method for bonding pattern electrodes using ultra-violet rays (UV) according to the third or fourth aspect described above.

Further features and advantages of the present invention can be obviously understood with reference to the accompanying drawings where same or similar reference numerals indicate same components.

### BRIEF DESCRIPTION OF THE DRAWINGS

FIG. 1 illustrates a cross-sectional view of a pattern electrode structure 100 being manufactured by a prior art bonding method of pattern electrodes.

FIG. 2 illustrates a cross-sectional view of a pattern electrode structure 200 being manufactured by a bonding method of pattern electrodes using ultra-violet rays in accordance with the present invention.

FIG. 3 illustrates a schematic view where pattern electrodes on TAB are bonded to pattern electrodes generally formed on three sides of one-body front and back glass panels.

FIG. 4 illustrates a thermal-pressure bonding process of an anisotropic conductive film in accordance with a prior art shown in FIG. 1, for bonding at long sides A and B and short sides A and B as shown in FIG. 3.

FIG. 5a illustrates a bonding process using ultra-violet rays in accordance with one embodiment of the present invention.

FIG. 5b illustrates a bonding process using ultra-violet rays in accordance with an alternative embodiment of the present invention.

### DETAILED DESCRIPTION

Hereinafter, structures and functions of embodiments in accordance with the present invention are described in more detail with reference to the appended drawings.

Recently, use of a PDP or an LCD has been increased sharply in the fields of display monitors or TVs. In manufacturing a PDP or an LCD, it is required to bond pattern electrode terminals formed on a front glass panel and a back glass panel to a tape automatic bonding (TAB), in order to control front pattern electrode terminals where pattern electrodes (address electrodes and power electrodes) are formed on a front glass panel and back pattern electrode terminals where pattern electrodes (address electrodes and power electrodes) are formed on a back glass panel. On TAB, the pattern electrodes of an FPC having a drive integrated circuit (IC) (hereinafter referred to “pattern electrodes for an IC terminal”) and the pattern electrodes of an FPC functioning as leads while not having a drive IC (hereinafter referred to “pattern electrodes for a terminal”), respectively, are formed.

In a prior art method for bonding the front and back pattern electrodes to TAB, a thermal-pressure bonding method of an anisotropic conductive film (ACF) is widely used where an ACF having conductive balls therein is pre-bonded between a plurality of front and back pattern electrodes and a plurality of pattern electrodes attached to TAB, and then the plurality of front and back pattern electrodes and the plurality of pattern electrodes attached to TAB are aligned with each other and are pressured together with being heated by a heater.

In an another prior art, a coating method has been used where the front and back pattern electrodes and the pattern electrodes of TAB are coated using a non-conductive paste (NCP) or a non-conductive film (NCF), together with being thermally pressured.

However, there are problems in a prior art thermal-pressure bonding method as follows:

1) Because of using a thermal-pressure bonding method, curing time is unstable and thus both a positioning decision error between the electrodes and a positioning decision error due to different thermal expansions between different materials occur. Therefore, an internal stress occurs ultimately and, as a result, electrode contacts are broken so that it is hard to embody a fine pitch between pattern electrodes;

2) In a thermal-pressure method of ACF, the price of an ACF itself is very high and a whole bonding method where a boning is required even in empty spaces between one TAB and an adjacent TAB must be used. Thus, such a thermal-pressure method of ACF is not cost-effective;

3) A heating device such as a hot bar or a heat block, etc., is separately required for a heating and pressure process, and thus the costs are increased. Further, tact time for manufacturing a PDP or an LCD is also increased due to increased process time for heating and cooling; and

4) Many bonding steps and many stations are required for performing an ACF attachment process and a pressure process. In this connection, the prices of devices or tools necessary for performing an ACF attachment process and a pressure process are significantly high and thus are not cost-effective. In addition, space-efficiency is very poor due to the use of many stations.

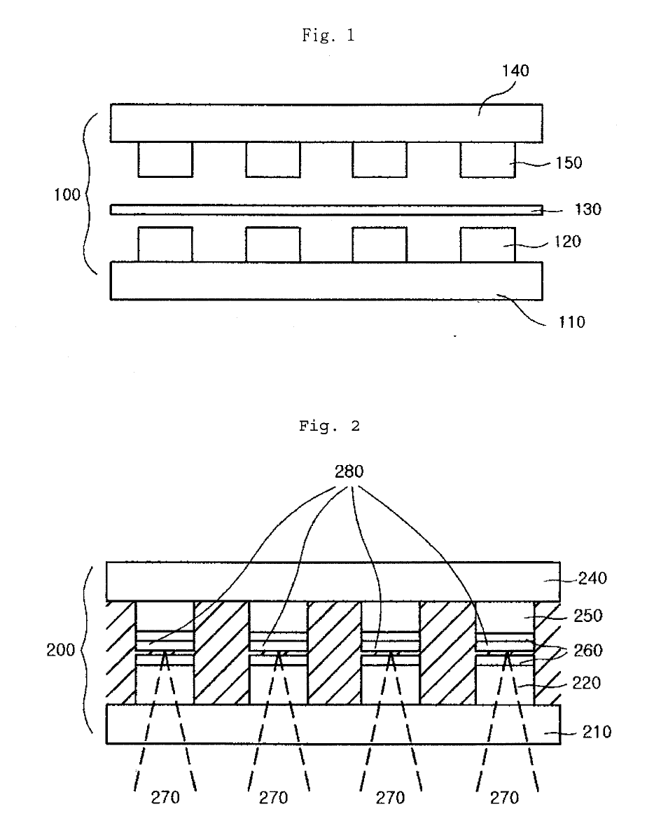

FIG. 1 illustrates a cross-sectional view of a pattern electrode structure 100 being manufactured by a prior art bonding method of pattern electrodes. The prior art bonding method of pattern electrodes will be described in more detail below.

As shown in FIG. 1, a plurality of pattern electrodes 120 (hereinafter referred to as “front or back pattern electrodes 120”) formed on a front or back glass panel 110 being used for manufacturing a PDP or an LCD is prepared. After that, a high-priced ACF 130 is pre-attached to the front or back pattern electrodes 120. Then, a plurality of pattern electrodes 150 formed on TAB 140 is aligned with the front or back pattern electrodes 120. After that, the front or back pattern electrodes 120 and the plurality of pattern electrodes 150 formed on TAB 140 are heated to a high temperature of approximately 200° C. by using a heating device (not shown) such as a hot bar or a heat block, etc., together with being pressured. Then, an ACF 130 between contact positions of the front or back pattern electrodes 120 and the plurality of pattern electrodes 150 formed on TAB 140 is melted and thus the front or back pattern electrodes 120 and the plurality of pattern electrodes 150 formed on TAB 140 are bonded.

FIG. 2 illustrates a cross-sectional view of a pattern electrode structure 200 being manufactured by a bonding method of pattern electrodes using UV in accordance with the present invention. As shown in FIG. 2, a plurality of pattern electrodes 220 formed on a front or back glass panel 210 being used in the present invention and a plurality of pattern electrodes 250 formed on TAB 240 are substantially the same as those being used in the bonding structure of pattern electrodes according to a prior art shown in FIG. 1. However, instead of employing an ACF 130 as shown in FIG. 1 and a heater, the present invention shown in FIG. 2 employs a UV curing agent 280 and UV 270 which are emitted from a UV emission device (not shown) and thus obtains a bonding structure of pattern electrodes by bonding the plurality of front or back pattern electrodes 220 and the plurality of pattern electrodes 250 formed on TAB 240 in a thermal-pressure method at a normal temperature. In a bonding using a thermal-pressure method, pressurization is made by using a certain pressure device. In order to apply a uniform pressure, a cushion sheet may be used between the certain pressure device and an FPC on which the pattern electrodes 250 of TAB 240 are formed. As a specific example of the cushion sheet, a silicon rubber having a thickness of approximately 0.3 mm may be used. Further, although FIG. 2 shows that a UV curing agent 280 is coated onto TAB 240, it is obvious by a skilled person in the art that a UV curing agent 280 is coated on the front or back pattern electrodes 220 of the front or back glass panel 210 to which TAB 240 is supposed to be attached.

More specifically, in the present invention, a plurality of pattern electrodes 220 formed on a front or back glass panel 210 and a plurality of pattern electrodes 250 formed on TAB 240 are respectively prepared. Reference numeral 260 shown in FIG. 2 refers to a coating layer 260 which is made by gold (Au) or silver (Ag) coated on surfaces of the pattern electrodes 220, 250 to be contacted. The coating layer 260 is fully disclosed in Korean patent application No. 10-2005-0077038, filed on Aug. 23, 2005, entitled “Improved bonding structure of pattern electrodes and method for bonding the same.” The Korean patent application No. 10-2005-0077038 is incorporated by reference herein. However, a skilled person in the art may fully understand that the coating layer 260 being used in the present invention is simply exemplary and may not be used, if necessary, in the present invention.

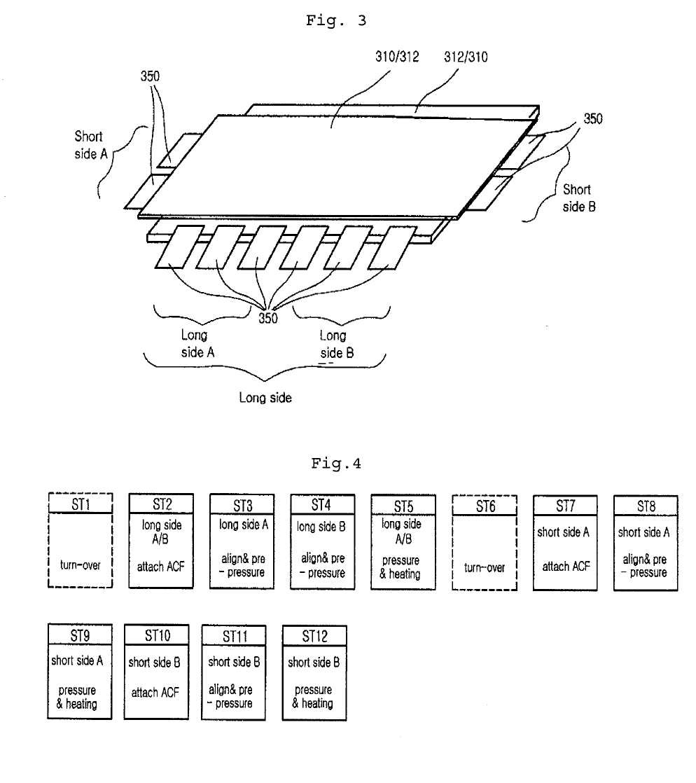

Now referring back to FIG. 2, a bonding method according to the present invention comprises a step of coating a UV curing agent 280 in a liquid state on a plurality of pattern electrodes 250 or a coating layer 260. The UV curing agent 280 in a liquid state is coated on TAB 240 by a dispenser (not shown) for dispensing a UV curing agent. That is, although only one front or back glass panel 110 and one TAB 140 are shown at an upper side as shown in a prior art of FIG. 1, a bonding is made in a real manufacturing process of an LCD or a PDP in a way that plural sets comprised of a front or back glass panel 110 and TAB 140 are placed in parallel with a certain interval. In this case, it is required to provide an ACF 130 for each empty space corresponding to each interval between one glass panel 110 and an adjacent glass panel 110 or between one TAB 140 and an adjacent TAB 140, which are placed in parallel, and then to apply heat with pressure. Therefore, the prior art shown in FIG. 1 has a problem that manufacturing costs are increased because a high-priced ACF (approximately 2,700 Korean Won per meter) must be used for each empty space where a bonding is not necessarily required. However, the present invention is cost-effective due to using a low-priced UV curing agent 280 (approximately 180 Korean Won per meter) and is further cost-effective because a UV curing agent 280 as shown in FIG. 2 is not required to be used for each empty space between one TAB and an adjacent TAB, as will be described later along with FIG. 3.

In addition, the present invention is characterized in that a bonding of a UV curing agent 280 is made at a normal temperature by using UV 270. Particularly, a bonding using UV 270 is made at a normal temperature so that there is no need to use a heating device separately, unlikely in a prior art which uses a thermal-pressure bonding method, and thus the present invention is cost-effective and decreases tact time for completing the whole manufacturing process. More specifically, it takes approximately 5 seconds necessary for a bonding process with heating (approximately 200° C.) and applying pressure in a prior art shown in FIG. 1, while it takes approximately 0.3 seconds necessary for a bonding process of a UV curing agent 280 at a normal temperature with applying pressure when using UV 270 with UV energy per unit area of 3 Watts/cm² in the present invention. Therefore, in the present invention, bonding time can be significantly reduced and space-efficiency is additionally increased because there is no need to use a heating device.

In the meanwhile, a UV curing agent in a liquid state is typically used for a UV curing agent 280 according to the present invention described above. As a specific example, the UV curing agent in a liquid state is selected among an acrylic type curing agent (e.g., Loctite 3736), an epoxy-type curing agent (e.g., Loctite 3337), and a silicon-type curing agent (e.g., Loctite 5031), all of which are available from Henkel Korea Co., located at Mapo Tower Bldg. 8F., 418 Mapo-Dong, Mapo-Gu, Seoul, Korea (Zip code 121-734).

FIG. 3 illustrates a schematic view where pattern electrodes on TAB are bonded to pattern electrodes generally formed on three sides of one-body front and back glass panels. More specifically, a plurality of pattern electrodes (not shown) formed on each TAB 350 is bonded to a plurality of pattern electrodes (not shown) formed on two sides (e.g., short side A and short side B) of one of one-body front and back glass panels 310,312, simultaneously or subsequently, and then is bonded to a plurality of pattern electrodes (not shown) formed on one side (e.g., long side) of the other glass panel of the front and back glass panels 310,312, or vice versa. That is, it is possible that a plurality of pattern electrodes (not shown) formed on each TAB 350 is bonded to a plurality of pattern electrodes (not shown) formed on one side (e.g., long side) of one of the front and back glass panels 310,312, and then is bonded to a plurality of pattern electrodes (not shown) formed on two sides (e.g., short side A and short side B) of the other glass panel of the front and back glass panels 310,312, simultaneously or subsequently. Further, in case of bonding at long side, it is possible either to carry out a bonding process all at once over the whole long side or to carry out a bonding process by dividing the long side into long side A and long side B and performing the bonding process over one of long sides A and B and then over the other one of long sides A and B subsequently. Although FIG. 3 shows that two TABs are attached to each of short sides A and B and six TABs are attached to long side, it is only an example for the purpose of explanation and therefore the number of TABs may be increased or reduced depending on necessity.

Further, a bonding between a plurality of pattern electrodes formed on a corresponding glass panel and a plurality of pattern electrodes formed on TAB 350 should be made under a condition that a front glass panel 310 has been attached to a back glass panel 312. This condition may require additionally a turn-over process of one-body front and back glass panels 310,312. That is, when, for example, a bonding process may begin in a state that a plurality of pattern electrodes formed on a glass is placed oppositely to a plurality of pattern electrodes formed on TAB 350 after all other processes prior to a bonding process are completed, a turn-over process of one-body front and back glass panels 310,312 is necessarily required. In addition, when a bonding structure in a state after a bonding process is completed (that is, a state that the pattern electrodes formed on glass panels 310,312 and the pattern electrodes formed on TAB 350 are bonded together) requires a condition with a 180 degree-rotated, reversed bonding structure for performing a subsequent process, a turn-over process may be required one more time. However, a skilled person in the art fully understands that a turn-over process described above may be used in case that it is necessary for a bonding process, or before and after the bonding process, and thus may not be necessarily required depending on a process design condition.

FIG. 4 illustrates a thermal-pressure bonding process of an anisotropic conductive film in accordance with a prior art shown in FIG. 1, for bonding at long sides A and B and short sides A and B as shown in FIG. 3.

Referring to FIG. 4, after turning one-body front and back glass panels 310,312 at station 1 (ST1), a glass panel structure is obtained as shown in FIG. 3. Then, at station 2 (ST2), ACF is attached to long sides A and B of, e.g., glass panel 312. Then, at station 3 (ST3), pattern electrodes formed on glass panel 312 and pattern electrodes formed on TAB 350 over long side A are aligned with each other and are pre-bonded with pre-pressure. Then, at station 4 (ST4), pattern electrodes formed on glass panel 312 and pattern electrodes formed on TAB 350 over long side B are aligned with each other and are pre-bonded with pre-pressure. Then, at station 5 (ST5), a bonding for the whole long sides A and B is made by heating with pressure. Then, at station 6 (ST6), a turn-over process is made for bonding short sides A and B. Then, at station 7 (ST7), ACF is attached to short side A of glass panel 310. Then, at station 8 (ST8), pattern electrodes formed on glass panel 310 and pattern electrodes formed on TAB 350 over short side A are aligned with each other and are pre-bonded with pre-pressure. Then, at station 9 (ST9), a bonding at short side A is made by heating with pressure. Then, station 10 (ST10), ACF is attached to short side B of glass panel 310. Then, at station 11 (ST11), pattern electrodes formed on glass panel 310 and pattern electrodes formed on TAB 350 over short side B are aligned with each other and are pre-bonded with pre-pressure. Then, at station 12 (ST12), a bonding at short side B is made by heating with pressure. With the above processes, a whole bonding process for bonding the pattern electrodes formed on glass panels 310,312 and the pattern electrodes formed on TAB 350 is completed. In a prior art embodiment shown in FIG. 4, although it is described that a turn-over process is required two times, this turn-over process may not be used at all or may be used only one time, as described above, and thus is shown in dot lines in FIG. 4. Further, a plurality of TABs 350 being used for a bonding process at long sides A and B and at short sides A and B is fed continuously one by one and ACF is coated on each TAB 350. However, a skilled person in the art fully understands that ACF may be coated on glass panels 310,312 where a plurality of pattern electrodes is formed.

In a bonding process for bonding pattern electrodes according to a prior art as shown in FIG. 4, there are problems as follows: 1) a total of 12 steps (or 10 or 11 steps in case that a turn-over step is not used at all or is used one time) is required; 2) additional costs incur due to the attachment of ACF over whole sides when performing an ACF attachment step; 3) costs are increased due to using a heating device when performing a heating process with pressure; 4) space-efficiency is reduced by using a heating device; and 5) process time is increased due to heating and cooling.

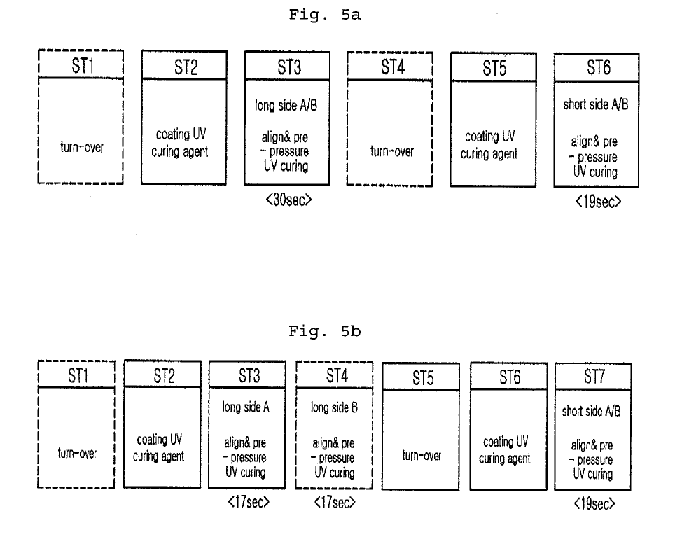

FIG. 5a illustrates a bonding process using ultra-violet rays in accordance with one embodiment of the present invention.

Referring to FIGS. 3 and 5a, after turning one-body glass panels 310,312 at station 1 (ST1) like FIG. 4, a glass panel structure is obtained as shown in FIG. 3. Then, at station 2 (ST2), a UV curing agent is coated on a plurality of TABs 350 to be attached to long sides A and B of, e.g., glass panel 312. In this case, a coating of a UV curing agent on TABs 350 is made over long sides A and B simultaneously or subsequently (in a case of coating one of long sides A and B and thereafter coating the other one of long sides A and B, for example, in an embodiment of FIG. 3), or a UV curing agent is coated on each TAB 350 while it is not coated on each empty space between one TAB and an adjacent TAB (for example, an empty space between one TAB 350 and an adjacent TAB 350 as shown in FIG. 3). Then, at station 3 (ST3), pattern electrodes formed on glass panel 312 and pattern electrodes formed on TAB 350 over long sides A and B are aligned with each other and a UV curing is made with pre-pressure. Then, at station 4 (ST4), a turn-over process is made for bonding short sides A and B. Then, at station 5 (ST5), a UV curing agent is coated on short sides A and B of glass panel 310, where a coating a UV curing agent on short sides A and B is made simultaneously or subsequently. Herein, a plurality of TABs 350 being used for a bonding process of long sides A and B and short sides A and B is fed continuously one by one and a UV curing agent is coated on each TAB 350, or a UV agent may be coated on glass panels 310,312 where a plurality of pattern electrodes are formed, corresponding to positions to which each TAB 350 is supposed to be attached. Then, at station 6 (ST6), pattern electrodes formed on glass panel 310 and pattern electrodes formed on TAB 350 over short sides A and B are aligned with each other and a UV curing is made with pre-pressure. With the above processes, a whole bonding process for bonding the pattern electrodes formed on glass panels 310,312 and the pattern electrodes formed on TABs 350 is completed.

In the meanwhile, FIG. 5b illustrates a bonding process using ultra-violet rays in accordance with an alternative embodiment of the present invention. Referring FIGS. 3 and 5b, an embodiment of FIG. 5b is substantially the same as an embodiment shown in FIG. 5a, except that a step of alignment and pre-pressure and a step of UV curing at station 3 (ST3) are made separately for long side A and long side B. Further, the time necessary for performing a process at station 3 (ST3) in FIG. 5a requires 30 seconds, while the time necessary for performing each process at stations 3 and 4 (ST3 and ST4) in FIG. 5b requires 17 seconds, respectively, and 34 seconds in total. However, as process time at station 3 (ST3) requires 30 seconds in FIG. 5a, station 3 (ST3) is a bottle neck process so that waiting time for performing a subsequent process is 30 seconds. In the meanwhile, as each process time at stations 3 and 4 (ST3 and ST4) requires 17 seconds and process time at station 7 (ST7) requires 19 seconds, station 7 (ST7) is a bottle neck process so that waiting time for performing a subsequent process is 19 seconds. Accordingly, although an embodiment in FIG. 5b includes one more additional process compared with an embodiment in FIG. 5a, an embodiment in FIG. 5b has shortened waiting time for performing a subsequent process so that time-efficiency for performing the whole processes is enhanced.

Although it is shown that a turn-over process is required two times in each embodiment shown in FIGS. 5a and 5b, this turn-over process may not be used at all or may be used only one time, like a turn-over process in FIG. 4, and thus is shown in dot lines in FIGS. 5a and 5b. Further, it is shown that a turn-over process is made at each station 1(ST1), respectively in FIGS. 5a and 5b, a skilled person in the art fully understands that a turn-over process may be performed after station 6 (ST6) and station 7 (ST7), respectively.

It is clearly understandable that, in either one case of bonding process embodiments shown in FIGS. 5a and 5b, the number of steps is reduced when compared with a bonding process of a prior art shown in FIG. 4, and process time is significantly reduced because a UV curing is made at a normal temperature and heating is not required.

### Advantageous Effect

According to a bonding structure of pattern electrodes using ultra-violet rays and a bonding method for bonding pattern electrodes using the same in accordance with the present invention, it is possible to accomplish the following advantages:

1. Pressurization is made at a normal temperature and curing is made stably so that both a positioning decision error between electrodes and a positioning decision error due to different thermal expansions between different materials are prevented and it is easy to embody a fine pitch.

2. Total costs are reduced due to using a low-priced UV curing agent and costs can be additionally reduced by not using a UV curing agent for each empty space between one Tab and an adjacent TAB, which requires no bonding.

3. Costs can be reduced by not using a heating device and tact time for manufacturing a PDP or an LCD is also decreased because heating and cooling are not required.

4. The number of bonding steps is reduced when compared with a prior art and therefore space-efficiency is significantly enhanced because a bonding process is made at a less number of stations.

As various modifications could be made in the constructions and method herein described and illustrated without departing from the scope of the present invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A bonding structure of pattern electrodes using ultra-violet rays (UV) comprising:
a front or back glass panel;
a plurality of front or back pattern electrodes formed on the front or back glass panel;
a tape automatic bonding (TAB);
a plurality of pattern electrodes formed on the TAB; and
a UV curing layer coated either on the plurality of front or back pattern electrodes or on the plurality of pattern electrodes formed on the TAB,
wherein a bonding between the plurality of front or back pattern electrodes and the plurality of pattern electrodes formed on the TAB is made in a way that the UV curing layer is cured at a normal temperature by UV emitted from a UV emission device, under a condition that the plurality of front or back pattern electrodes and the plurality of pattern electrodes formed on the TAB are aligned with each other and a certain pressure is applied thereon by a certain pressure device.

2. The bonding structure of pattern electrodes using ultra-violet rays (UV) of claim 1, wherein the certain pressure is applied uniformly by using a certain cushion sheet, when the certain pressure is applied by the certain pressure device.

3. The bonding structure of pattern electrodes using ultra-violet rays (UV) of claim 1, wherein the UV curing layer is in a liquid state and is selected from anyone among an acrylic type curing agent, an epoxy-type curing agent, and a silicon-type curing agent.

4. A method for bonding pattern electrodes using ultra-violet rays (UV) comprising:
a step of preparing a plurality of front or back pattern electrodes formed on a front or back glass panel;
a step of preparing a plurality of pattern electrodes formed on each of a plurality of tape automatic bondings (TABs);
a step of coating a UV curing layer either on the plurality of front or back pattern electrodes or on the plurality of TABs;
a step of aligning the plurality of front or back pattern electrodes with the plurality of pattern electrodes formed on the plurality of TABs; and
a step of curing the UV curing layer by using certain UV, while applying a certain pressure on the plurality of front or back pattern electrodes and the plurality of pattern electrodes formed on the plurality of TABs by a certain pressure device.

5. The method for bonding pattern electrodes using ultra-violet rays (UV) of claim 4, wherein the certain pressure is applied uniformly by using a certain cushion sheet, when the certain pressure is applied by the certain pressure device.

6. The method for bonding pattern electrodes using ultra-violet rays (UV) of claim 4, wherein the UV curing layer is in a liquid state and is selected from anyone among an acrylic type curing agent, an epoxy-type curing agent, and a silicon-type curing agent.

7. A method for bonding pattern electrodes using ultra-violet rays (UV) comprising:
a) a step of coating a UV curing agent on a plurality of TABs, each of which is supposed to be attached to long sides A and B of one of two glass panels and a plurality of pattern electrodes is formed on;
b) a step of aligning a plurality of pattern electrodes formed on the one of the two glass panels with the plurality of pattern electrodes formed on the plurality of TABs over the long sides A and B, and of UV curing while applying pressure;
c) a step of coating the UV curing agent on another plurality of TABs, each of which is supposed to be attached to short sides A and B of the other glass panel and another plurality of pattern electrodes is formed on; and
d) a step of aligning a plurality of pattern electrodes formed on the other glass panel with the another plurality of pattern electrodes formed on the another plurality of TABs over the short sides A and B, and of UV curing while applying pressure,
wherein the UV curing agent is coated only on the plurality of TABs and the another plurality of TABs, or on positions of the plurality of pattern electrodes of the two glass panels to which the plurality of TABs and the another plurality of TABs are supposed to be attached.

8. The method for bonding pattern electrodes using ultra-violet rays (UV) of claim 7, wherein the method further comprises a step of turning-over the two glass panels between the step of b) and the step of c).

9. The method for bonding pattern electrodes using ultra-violet rays (UV) of claim 8, wherein the method further comprises a step of turning-over the two glass panels before the step of a) or after the step of d).

10. A method for bonding pattern electrodes using ultra-violet rays (UV) comprising:
a) a step of coating a UV curing agent on a plurality of TABs, each of which is supposed to be attached to long sides A and B of one of two glass panels and a plurality of pattern electrodes is formed on;
b) a step of aligning a plurality of pattern electrodes formed on the one of the two glass panels with the plurality of pattern electrodes formed on the plurality of TABs over the long side A, and of UV curing while applying pressure;
c) a step of aligning the plurality of pattern electrodes formed on the one of the two glass panels with the plurality of pattern electrodes formed on the plurality of TABs over the long side B, and of UV curing while applying pressure;
d) a step of coating the UV curing agent on another plurality of TABs, each of which is supposed to be attached to short sides A and B of the other glass panel and another plurality of pattern electrodes is formed on; and
e) a step of aligning a plurality of pattern electrodes formed on the other glass panel with the another plurality of pattern electrodes formed on the another plurality of TABs over the short sides A and B, and of UV curing while applying pressure,
wherein the UV curing agent is coated only on the plurality of TABs and the another plurality of TABs, or on positions of the plurality of pattern electrodes of the two glass panels to which the plurality of TABs and the another plurality of TABs are supposed to be attached.

11. The method for bonding pattern electrodes using ultra-violet rays (UV) of claim 10, wherein the method further comprises a step of turning-over the two glass panels between the step of c) and the step of d).

12. The method for bonding pattern electrodes using ultra-violet rays (UV) of claim 11, wherein the method further comprises a step of turning-over the two glass panels before the step of a) or after the step of e).

13. A plasma display panel (PDP) having the bonding structure of pattern electrodes using ultra-violet rays (UV) of claim 1.

14. A liquid crystal display (LCD) having the bonding structure of pattern electrodes using ultra-violet rays (UV) of claim 1.

15. A plasma display panel (PDP) having a bonding structure of pattern electrodes which is manufactured by using a method for bonding pattern electrodes using ultra-violet rays (UV) of claim 4.

16. A liquid crystal display (LCD) having a bonding structure of pattern electrodes which is manufactured by using a method for bonding pattern electrodes using ultra-violet rays (UV) of claim 4.

17. A plasma display panel (PDP) having a bonding structure of pattern electrodes which is manufactured by using a method for bonding pattern electrodes using ultra-violet rays (UV) of claim 7.

18. A liquid crystal display (LCD) having a bonding structure of pattern electrodes which is manufactured by using a method for bonding pattern electrodes using ultra-violet rays (UV) of claim 7.
